(19) United States
(12) Patent Application Publication
(10) Pub. No.: US 2011/0129732 A1
(43) Pub. Date: Jun. 2, 2011

(54) COMPRESSED POWDER 3D BATTERY ELECTRODE MANUFACTURING

(75) Inventors: Robert Z. Bachrach, Burlingame, CA (US); Sergey D. Lopatin, Morgan Hill, CA (US); Connie P. Wang, Mountain View, CA (US); Donald J.K. Olgado, Palo Alto, CA (US)

(73) Assignee: APPLIED MATERIALS, INC., Santa Clara, CA (US)

(21) Appl. No.: 12/839,051

(22) Filed: Jul. 19, 2010

Related U.S. Application Data
(60) Provisional application No. 61/265,577, filed on Dec. 1, 2009.

(51) Int. Cl. H01M 4/70; H01M 4/485; H01M 4/52; H01M 4/58; H01M 4/505; H01M 4/38; H01M 4/583; B05C 13/00; B05C 11/00; B05B 5/025; B05B 7/16; B05B 7/20; B05C 1/08; B05C 5/00

(52) U.S. Cl. 429/220; 429/239; 429/231.1; 429/223; 429/231.2; 429/221; 429/224; 429/231.3; 429/231.5; 429/231.95; 429/231.8; 429/218.1; 118/500; 118/610; 118/72; 118/621; 118/302; 239/79; 118/258; 118/300

(57) ABSTRACT

Embodiments of the invention contemplate forming an electrochemical device and device components, such as a battery cell or supercapacitor, using thin-film or layer deposition processes and other related methods for forming the same. In one embodiment, a battery bi-layer cell is provided. The battery bi-layer cell comprises an anode structure comprising a conductive collector substrate, a plurality of pockets formed on the conductive collector substrate by conductive microstructures comprising a plurality of columnar projections, and an anodically active powder deposited in and over the plurality of pockets, an insulative separator layer formed over the plurality of pockets, and a cathode structure joined over the insulative separator.

### CROSS-REFERENCE TO RELATED APPLICATIONS

This application claims benefit of U.S. provisional patent application Ser. No. 61/265,577 (Attorney Docket No. 14080L), filed Dec. 1, 2009, which is herein incorporated by reference in its entirety.

### BACKGROUND OF THE INVENTION

1. Field of the Invention

Embodiments of the present invention generally relate to lithium-ion batteries and battery cell components, and more specifically, to a system and method for fabricating such batteries and battery cell components using processes that form three-dimensional porous structures.

2. Description of the Related Art

High-capacity energy storage devices, such as lithium-ion (Li-ion) batteries, are used in a growing number of applications, including portable electronics, medical, transportation, grid-connected large energy storage, renewable energy storage, and uninterruptible power supply (UPS).

One method for battery cell electrode manufacturing is principally based on slit coating of viscous powder slurry mixtures of cathodically or anodically active material onto a conductive current collector followed by prolonged heating to form a dried cast sheet and prevent cracking. The thickness of the electrode after drying which evaporates the solvents is finally determined by compression or calendaring which adjusts the density and porosity of the final layer. Slit coating of viscous slurries is a highly developed manufacturing technology which is very dependent on the formulation, formation, and homogenation of the slurry. The formed active layer is sensitive to the rate and thermal details of the drying process.

Because the dried cast sheet must adhere well to the metal current collector, the mixture typically includes a binder which promotes adhesion. Binding is further augmented by the compression process which adjusts the density of the active sheet and also embeds some of the bound particles into the metal current collector.

Among other problems and limitations of this technology is the slow and costly drying component which has both a large long footprint and an elaborate collection and recycling system for the evaporated volatile components. Many of these are volatile organic compounds which additionally require an elaborate abatement system. Further, the resulting electrical conductivity of these types of electrodes also limits the thickness of the electrode and thus the volume of the electrode.

For most energy storage applications, the charge time and energy capacity of energy storage devices are important parameters. In addition, the size, weight, and/or expense of such energy storage devices are significant specifications.

Accordingly, there is a need in the art for faster charging, higher capacity energy storage devices that are smaller, lighter, and can be more cost effectively manufactured at a high production rate.

### SUMMARY OF THE INVENTION

Embodiments of the invention contemplate forming an electrochemical device and device components, such as a battery cell or supercapacitor, using thin-film or layer deposition processes and other related methods for forming the same. In one embodiment, a battery bi-layer cell is provided. The battery bi-layer cell comprises an anode structure comprising a conductive collector substrate, a plurality of pockets formed on the conductive collector substrate by conductive microstructures comprising a plurality of columnar projections, and an anodically active powder deposited in and over the plurality of pockets, an insulative separator layer formed over the plurality of pockets, and a cathode structure joined over the insulative separator.

In another embodiment, an anode electrode structure for use in an electrochemical cell device is provided. The anode structure comprises a conductive collector substrate, a container layer comprising a plurality of porous pockets formed on one or more surfaces of the conductive collector substrate by conductive microstructures comprising a plurality of meso-porous structures formed over a plurality of columnar projections, and an anodically active powder deposited into and over the plurality of pockets.

In another embodiment, an anode electrode structure for use in an electrochemical cell device is provided. The anode structure comprises a collector metal foil substrate onto which a container layer is deposited consisting of, a plurality of pockets or wells formed from thin walled porous conductive microstructures including a plurality of dendrites or other porous forms formed comprising or over the pocket walls. Powder is deposited into and over the plurality of pockets. The net deposition may be adjusted so the final density and thickness can be determined in a calendaring process. An insulative separator may be formed over the active material container layer.

In another embodiment, a cathode electrode structure for use in an electrochemical cell device is provided and formed in a similar manner. The cathode electrode structure comprises a container layer formed on the collector substrate. The nano-patterned or micro-patterned container layer substrate comprising aluminum or alloys thereof formed as a plurality of pockets in the nano-patterned or micro-patterned substrate. Powder is deposited into and over the plurality of pockets, and an insulative separator is formed over the active material layer.

In yet another embodiment, a battery cell is provided. The battery cell comprises an anode electrode structure comprising a metal collector substrate, a container layer with a plurality of pockets formed on the surface by porous conductive microstructures comprising a plurality of dendrites or other structures formed over a plurality of columnar projections. Powder is deposited into and over the plurality of pockets, an insulative separator is formed over the container layer, and a similarly fabricated cathode electrode structure is formed over the insulative separator.

In yet another embodiment, an anode electrode structure for use in an electrochemical cell device is provided. The anode electrode structure comprises a substrate having a surface that is conductive, a plurality of pockets formed on the surface by conductive microstructures comprising a plurality of dendrites formed over a plurality of columnar projections, a powder deposited over the plurality of pockets, and an insulative separator formed over the plurality of pockets. In one embodiment, the columnar projections are formed using a plating process. In another embodiment, the columnar projections are formed using an embossing process.

In yet another embodiment, a cathode electrode structure for use in an electrochemical device. The cathode electrode structure comprising a micro-patterned conductive collector substrate comprising aluminum or alloys thereof, a plurality of pockets formed on one or more surfaces of the micro-patterned substrate, and a cathodically active powder deposited into and over the plurality of pockets. In certain embodiments, an insulative separator layer is formed over the plurality of pockets.

In yet another embodiment, a battery is provided. The battery comprises an anode structure comprising a substrate having a surface that is conductive, a plurality of pockets formed on the surface by conductive microstructures comprising a plurality of dendrites formed over a plurality of columnar projections, and a powder deposited over the plurality of pockets, an insulative separator formed over the plurality of pockets, and a cathode structure formed over the insulative separator.

In yet another embodiment, a substrate processing system for processing a flexible conductive substrate is provided. The substrate processing system comprises a microstructure formation chamber configured to form a plurality of conductive pockets over a flexible conductive substrate, an active material deposition chamber for depositing electro-active powders over the plurality of conductive pockets, and a substrate transfer mechanism configured to transfer the flexible conductive substrate among the chambers, comprising a feed roll configured to retain a portion of the flexible conductive substrate, and a take up roll configured to retain a portion of the flexible conductive substrate, wherein the substrate transfer mechanism is configured to activate the feed rolls and the take up rolls to transfer the flexible conductive substrate in and out of each chamber, and hold the flexible conductive substrate in a processing volume of each chamber. In certain embodiments, the flexible conductive substrate has a substantially vertical orientation. In certain embodiments, the flexible conductive substrate has a substantially horizontal orientation.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram of a Li-ion battery cell bi-layer electrically connected to a load according to embodiments described herein;

FIGS. 2A-2D are schematic cross-sectional views of an anode structure at various stages of formation, according to embodiments described herein;

FIG. 3 illustrates an anode structure after the formation of a separator layer over a container layer comprising conductive microstructures and powder, according to embodiments described herein;

FIG. 4A schematically illustrates one embodiment of a vertical processing system according to embodiments described herein;

FIG. 4B is a schematic sectional top view of an embossing chamber according to embodiments described herein;

FIG. 4C is a schematic sectional top view of one embodiment of a powder deposition chamber according to embodiments described herein;

FIG. 4D is a schematic sectional top view of one embodiment of a compression chamber according to embodiments described herein;

FIG. 5A is a perspective top view of a dual sided embossed micro-patterned substrate formed according to embodiments described herein;

FIG. 5B is a cross-sectional view of an embossed substrate taken along line 5B-5B of FIG. 5A according to embodiments described herein;

FIG. 6 is a process flow chart summarizing one embodiment of a method for forming an anode structure according to embodiments described herein;

FIG. 7 is a process flow chart summarizing one embodiment of a method for forming a cathode structure according to embodiments described herein;

FIG. 8 is a process flow chart summarizing one embodiment of a method for forming an anode structure according to embodiments described herein;

FIG. 9 is a process flow chart summarizing a method for forming a lithium-ion battery, according to embodiments described herein;

FIG. 10A is a schematic representation of a scanning electron microscope (SEM) image of one embodiment of a copper-tin container structure prior to deposition of powder;

FIG. 10B is a schematic representation of a scanning electron microscope (SEM) image of the copper-tin container structure of FIG. 10A after deposition of a powder over the copper-tin structure;

FIG. 11A is a schematic representation of a scanning electron microscope (SEM) image of a copper-tin container structure after deposition of graphite and a water soluble binder;

FIG. 11B is a schematic representation of a scanning electron microscope (SEM) image of a copper-tin container structure after deposition of graphite and a water soluble binder; and

FIG. 12 is a schematic representation of a scanning electron microscope (SEM) image of a cross-section of a copper-tin container structure filled with graphite powder.

To facilitate understanding, identical reference numerals have been used, wherever possible, to designate identical elements that are common to the figures. It is contemplated that elements and/or process steps of one embodiment may be beneficially incorporated in other embodiments without additional recitation.

### DETAILED DESCRIPTION

Embodiments of the invention contemplate apparatus and other related methods for forming an electrochemical device, such as a battery or supercapacitor, and components thereof using thin-film deposition processes and other methods for forming the same. Certain embodiments described herein include the manufacturing of battery cell electrodes by incorporating powders into three-dimensional conductive container microstructures to form active layers on substrates, for example, copper for anodes and aluminum for cathodes. In certain embodiments, the three-dimensional anode container structure is formed by a porous electroplating process. In certain embodiments, the three-dimensional cathode container structure is formed using embossing techniques. In certain embodiments, the three-dimensional cathode container structure is formed by a variety of patterning techniques including, for example, embossing techniques and nano-imprinting techniques. In certain embodiments, the three-dimensional cathode container structure comprises a wire mesh structure. The formation of the three-dimensional structure determines the thickness of the electrode and provides pockets or wells into which the anodically active or cathodically active powders can be deposited.

In certain embodiments, the porous container structure comprises directly active electrode materials such that the addition of powders produces a composite electrode structure.

While the particular apparatus in which the embodiments described herein can be practiced is not limited, it is particularly beneficial to practice the embodiments on a web-based roll-to-roll system sold by Applied Materials, Inc., Santa Clara, Calif. Exemplary roll-to-roll and discrete substrate systems on which the embodiments described herein may be practiced are described herein and in further detail in commonly assigned U.S. Provisional Patent Application Ser. No. 61/243,813, (Attorney Docket No. APPM/014044/ATG/ATG/ESONG), titled APPARATUS AND METHODS FOR FORMING ENERGY STORAGE OR PV DEVICES IN A LINEAR SYSTEM, which is herein incorporated by reference in its entirety.

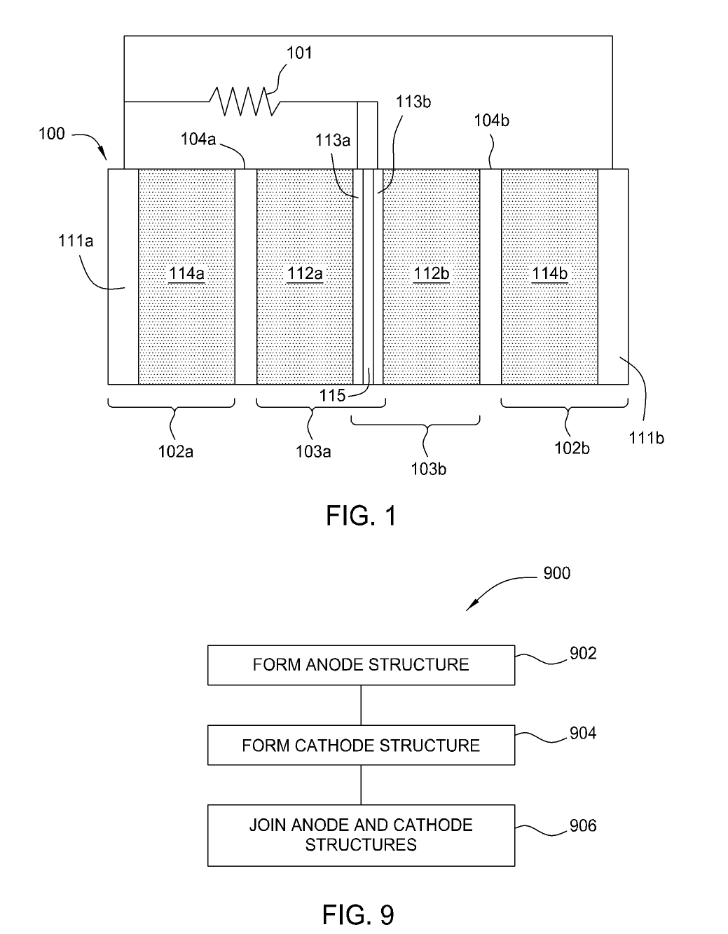

FIG. 1 is a schematic diagram of a single sided Li-ion battery cell bi-layer 100 electrically connected to a load 101, according to one embodiment described herein. The primary functional components of Li-ion battery cell bi-layer 100 include anode structures 102a, 102b, cathode structures 103a, 103b, separator layers 104a, 104b, and an electrolyte (not shown) disposed within the region between current collectors 111a, 111b, 113a, and 113b. A variety of materials may be used as the electrolyte, for example, a lithium salt in an organic solvent. The Li-ion battery cell 100 may be hermetically sealed with electrolyte in a suitable package with leads for the current collectors 111a, 111b, 113a, and 113b. The anode structures 102a, 102b, cathode structures 103a, 103b, and fluid-permeable separator layers 104a, 104b may be immersed in the electrolyte in the region formed between the current collectors 111a and 113a and the region formed between the current collectors 111b and 113b. An insulator layer 115 may be disposed between current collector 113a and current collector 113b.

Anode structures 102a, 102b and cathode structures 103a, 103b each serve as a half-cell of Li-ion battery 100, and together form a complete working bi-layer cell of Li-ion battery 100. Anode structures 102a, 102b each may include a metal current collector 111a, 111b and a first electrolyte containing material 114 (114a, 114b), such as a carbon-based intercalation host material for retaining lithium ions, having a container layer. Similarly, cathode structures 103a, 103b each may include a current collector 113a and 113b respectively and a second electrolyte containing material 112 (112a, 112b), such as a metal oxide, for retaining lithium ions, having a container layer. The current collectors 111a, 111b, 113a, and 113b may be made of electrically conductive material such as metals. In some cases, a separator layer 104, which is an insulating, porous, fluid-permeable layer, for example, a dielectric layer, may be used to prevent direct electrical contact between the components in the anode structures 102a, 102b and the cathode structures 103a, 103b.

The electrolyte containing porous material on the cathode side of the Li-ion battery 100, or positive electrode, may comprise a lithium-containing metal oxide, such as lithium cobalt dioxide (LiCoO₂) or lithium manganese dioxide (LiMnO₂). The electrolyte containing porous material may be made from a layered oxide, such as lithium cobalt oxide, an olivine, such as lithium iron phosphate, or a spinel, such as lithium manganese oxide. In non-lithium embodiments, an exemplary cathode may be made from TiS₂ (titanium disulfide). Exemplary lithium-containing oxides may be layered, such as lithium cobalt oxide (LiCoO₂), or mixed metal oxides, such as LiNiₓCO₁₋₂ₓMnO₂, LiNi_{0.5}Mn_{1.5}O₄, Li(Ni_{0.8}CO_{0.15}Al_{0.05})O₂, LiMn₂O₄. Exemplary phosphates may be iron olivine (LiFePO₄) and it is variants (such as LiFe₁₋ₓMgPO₄), LiMoPO₄, LiCoPO₄, LiNiPO₄, Li₃V₂(PO₄)₃, LiVOPO₄, LiMP₂O₇, or LiFe_{1.5}P₂O₇. Exemplary fluorophosphates may be LiVPO₄F, LiAlPO₄F, Li₅V(PO₄)₂F₂, Li₅Cr(PO₄)₂F₂, Li₂CoPO₄F, or Li₂NiPO₄F. Exemplary silicates may be Li₂FeSiO₄, Li₂MnSiO₄, or Li₂VOSiO₄. An exemplary non-lithium compound is Na₅V₂(PO₄)₂F₃.

The electrolyte containing porous material on the anode side of the Li-ion battery 100, or negative electrode, may be made from materials such as graphitic particles dispersed in a polymer matrix and/or various fine powders, for example, micro-scale or nano-scale sized powders. Additionally, microbeads of silicon, tin, or lithium titanate (Li₄Ti₅O₁₂) may be used with, or instead of, graphitic microbeads to provide the conductive core anode material. It should also be understood that although a Li-ion battery cell bi-layer 100 is depicted in FIG. 1, the embodiments described herein are not limited to Li-ion battery cell bi-layer structures. It should also be understood, that the anode and cathode structures may be connected either in series or in parallel.

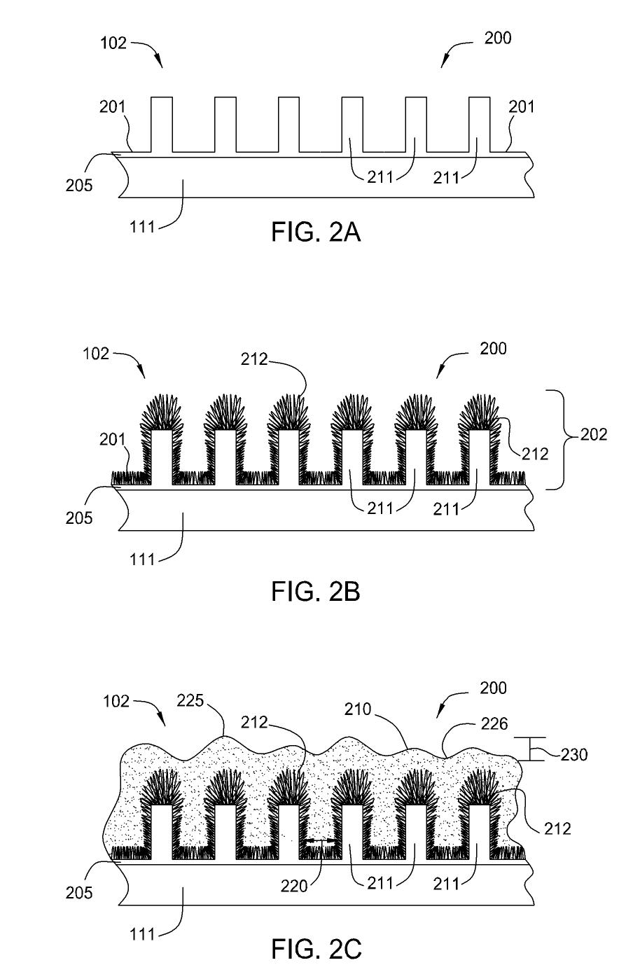

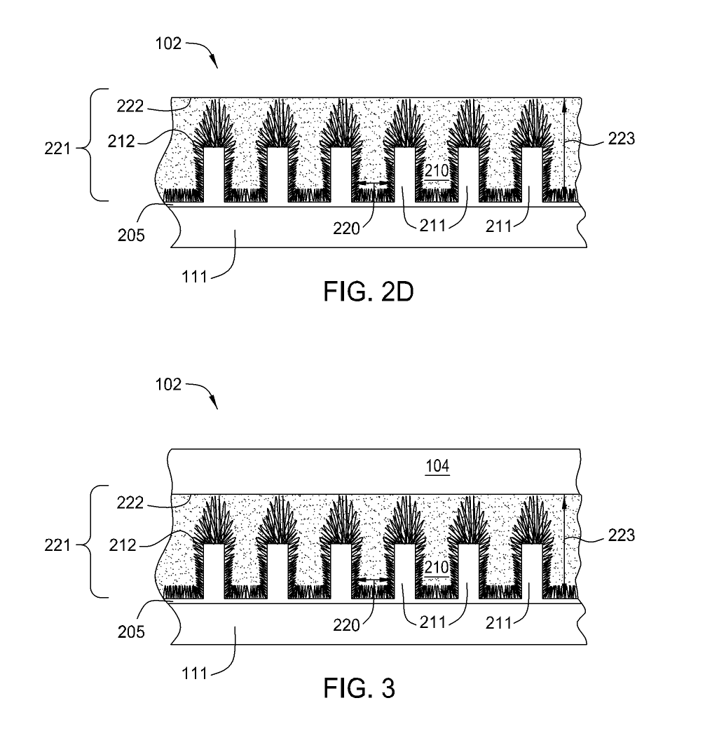

FIGS. 2A-2D are schematic cross-sectional views of an anode structure 102 at various stages of formation, according to embodiments described herein. In FIG. 2A, the current collector 111 and the container layer 202 is schematically illustrated prior to the deposition of an anodically active powder 210. In one embodiment, current collector 111 is a conductive substrate (e.g., metallic foil, sheet, and plate) and may have an insulating coating disposed thereon. In one embodiment, the current collector 111 may include a relatively thin conductive layer disposed on a host substrate comprising one or more conductive materials, such as a metal, plastic, graphite, polymers, carbon-containing polymer, composites, or other suitable materials. Examples of metals that current collector 111 may be comprised of include copper (Cu), zinc (Zn), nickel (Ni), cobalt (Co), palladium (Pd), platinum (Pt), tin (Sn), ruthenium (Ru), stainless steel, alloys thereof, and combinations thereof. In one embodiment, the current collector 111 is perforated.

Alternatively, current collector 111 may comprise a host substrate that is non-conductive, such as a glass, silicon, and plastic or polymeric substrate that has an electrically conductive layer formed thereon by means known in the art, including physical vapor deposition (PVD), electrochemical plating, electroless plating, and the like. In one embodiment, current collector 111 is formed out of a flexible host substrate. The flexible host substrate may be a lightweight and inexpensive plastic material, such as polyethylene, polypropylene or other suitable plastic or polymeric material, with a conductive layer formed thereon. In one embodiment, the conductive layer is between about 10 and 15 microns thick in order to minimize resistive loss. Materials suitable for use as such a flexible substrate include a polyimide (e.g., KAPTON™ by DuPont Corporation), polyethyleneterephthalate (PET), polyacrylates, polycarbonate, silicone, epoxy resins, silicone-functionalized epoxy resins, polyester (e.g., MYLAR™ by E.I. du Pont de Nemours & Co.), APICAL AV manufactured by Kanegaftigi Chemical Industry Company, UPILEX manufactured by UBE Industries, Ltd.; polyethersulfones (PES) manufactured by Sumitomo, a polyetherimide (e.g., ULTEM by General Electric Company), and polyethylenenaphthalene (PEN). Alternately, the flexible substrate may be constructed from a relatively thin glass that is reinforced with a polymeric coating.

As shown, current collector 111 has a container layer 202 disposed on a surface 201 thereof. The container layer 202 comprises conductive microstructures 200 with pockets or wells 220 formed therebetween. In one embodiment, the container layer 202 has a thickness between about 10 μm to about 200 μm, for example, between about 50 μm to about 100 μm. Conductive microstructures 200 greatly increase the effective surface area of current collector 111 and reduce the distance that charge must travel in the intercalation layer of anode structure 102 before entering current collector 111. Thus, the formation of conductive microstructures 200 on surface 201 reduces the charge/discharge time and internal resistance of an energy storage device that is configured with anode structure 102. In FIG. 2A, conductive microstructures 200 are depicted schematically as rectangular projections, oriented perpendicular to surface 201. Different configurations of conductive microstructures 200 are contemplated by embodiments described herein. The conductive microstructures may comprise materials selected from the group comprising copper, tin, silicon, cobalt, titanium, alloys thereof, and combinations thereof. Exemplary plating solutions and process conditions for formation of the conductive microstructures 200 are described in commonly assigned U.S. patent application Ser. No. 12/696,422, entitled, POROUS THREE DIMENSIONAL COPPER, TIN, COPPER-TIN, COPPER-TIN-COBALT, AND COPPER-TIN-COBALT-TITANIUM ELECTRODES FOR BATTERIES AND ULTRA CAPACITORS, to Lopatin et al., filed on Jan. 29, 2010, which is herein incorporated by reference in its entirety.

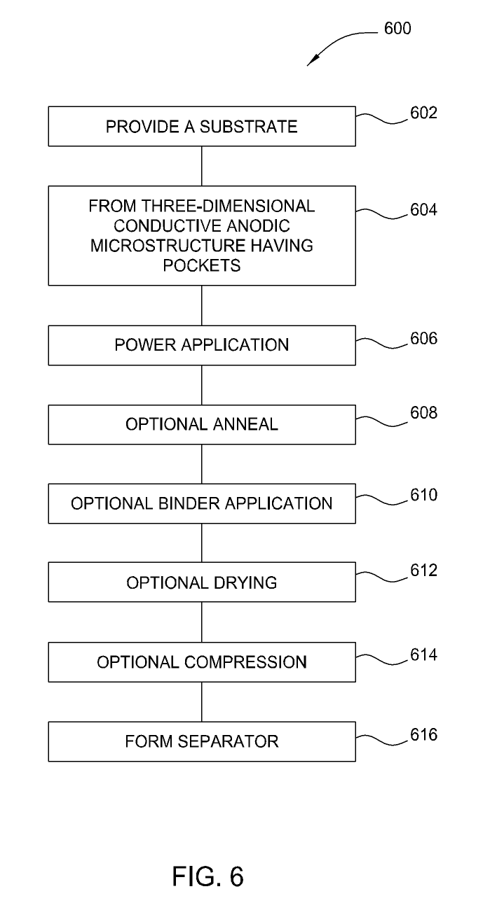

In one embodiment, conductive microstructures 200 on current collector 111 are formed as a three dimensional, columnar growth of material by use of a high plating rate electroplating process performed at current densities above the limiting current (i_{L}). In this way, columnar projections 211 or “posts” in the conductive microstructures 200 may be formed on surface 201. The diffusion-limited electrochemical plating process by which conductive microstructures 200 are formed is described below in further detail in block 604 of FIG. 6, in which the electro-plating limiting current is met or exceeded, thereby producing a low-density metallic columnar structure on surface 201 rather than a conventional high-density conformal film. In another embodiment, the substrate may be roughened by chemically treating the surface of the substrate to increase the surface area, and/or patterned and etched using methods known in the art for patterning metallic films. In one embodiment, current collector 111 is a copper-containing foil or a substrate having a layer of copper-containing metal deposited thereon, and therefore has a copper or copper alloy surface. In such an embodiment, a copper electro-plating process may be used to form columnar projections 211. Columnar projections 211 may also be formed by performing electroplating processes on other surfaces besides the copper-containing surfaces. For example, surface 201 may include a surface layer of any other metal that may act as a catalytic surface for the subsequent formation of subsequent material, such as silver (Ag), iron (Fe), nickel (Ni), cobalt (Co), palladium (Pd), and platinum (Pt), among others.

In one embodiment, the columnar projections 211 may be formed using an embossing process or nano-imprinting as described below.

To aid in the electrochemical deposition of columnar projections 211, current collector 111 may include a conductive seed layer 205 that has been deposited thereon. Conductive seed layer 205 preferably comprises a copper seed layer or alloys thereof. Other metals, particularly noble metals, may also be used for conductive seed layer 205. Conductive seed layer 205 may be deposited on current collector 111 by techniques well known in the art, including physical vapor deposition (PVD), chemical vapor deposition (CVD), thermal evaporation, and electroless deposition techniques, among others. Alternatively, columnar projections 211 may be formed by an electrochemical plating process directly on current collector 111, i.e., without conductive seed layer 205.

FIG. 2B schematically illustrates conductive microstructures 200 including optional meso-porous structures 212 formed over columnar projections 211, according to an embodiment of the invention. In one embodiment, the meso-porous structures 212 are high-surface-area, meso-porous structures comprised of a plated metal or metal alloy. In one embodiment, meso-porous structures 212 are formed by an electrochemical plating process in which the over potential, or applied voltage used to form the meso-porous structures 212 is significantly greater than that used to form the columnar projections 211, thereby producing a three-dimensional, low-density metallic meso-porous structure on columnar projections 211. In another embodiment, meso-porous structures 212 are formed by an electroless plating process. Meso-porous structures 212 have been demonstrated to increase the conductive surface area of current collector 111 significantly more than columnar projections 211 alone. In one embodiment, the meso-porous structures 212 may increase the conductive surface area of current collector 111 by a factor of 10 to 100.

In one embodiment, the conductive microstructures form a layer that has a density that is between about 10% and about 85% of a solid film formed from the same material. In one embodiment, the conductive microstructures form a layer that has a density that is between about 20% and about 50% of a solid film formed from the same material.

In certain embodiments, the conductive microstructures 200 comprise an additional layer formed over the meso-porous structures 212 and the columnar projections 211, for example, a tin layer. In certain embodiments, the additional layer may be deposited directly over the columnar projections. This additional layer can be formed by an electrochemical plating process. The additional layer provides high capacity and long cycle life for the electrode to be formed. In one embodiment, the meso-porous structures 212 and the columnar projections 211 comprise a copper-tin alloy and the additional layer comprises tin. Exemplary additional layers and processes for forming such additional layers are described in commonly assigned U.S. patent application Ser. No. 12/826,204, filed Jun. 29, 2010, to Lopatin et al., titled PASSIVATION FILM FOR SOLID ELECTROLYTE INTERFACE OF THREE DIMENSIONAL COPPER CONTAINING ELECTRODE IN ENERGY STORAGE DEVICE, which is herein incorporated by reference in its entirety.

In certain embodiments, it may be desirable to plate tin particles onto the current collector 111. In certain embodiments, tin particles are plated into the three-dimensional conductive microstructures 200. For example, tin nano-particles may be plated into the columnar projections 211 or the meso-porous structures 212 and large tin particles may be plated into the middle of the conductive microstructures 200. In certain embodiments, tin particles are plated into a three-dimensional copper-tin alloy. It has been found that the embedding of tin into the three-dimensional conductive microstructures increases the density of active material present in the three-dimensional conductive structure. Exemplary techniques for the deposition of tin particles into conductive microstructures are described in commonly assigned U.S. Provisional Patent Application Ser. No. 61/254,365, filed Oct. 23, 2009, to Lopatin et al., titled NUCLEATION AND GROWTH OF TIN PARTICLES INTO THREE DIMENSIONAL COMPOSITE ACTIVE ANODE FOR LITHIUM HIGH CAPACITY ENERGY STORAGE DEVICE, which is herein incorporated by reference in its entirety.

FIG. 2C illustrates the current collector 111 and the container layer 202 after the deposition of the powder 210 into the plurality of pockets 220 formed by the conductive microstructures 200, according to embodiments described herein. In one embodiment, the powder 210 comprises anodically active particles selected from the group comprising graphite, graphene hard carbon, carbon black, carbon coated silicon, tin particles, copper-tin particles, tin oxide, silicon carbide, silicon (amorphous or crystalline), silicon alloys, doped silicon, lithium titanate, any other appropriately electro-active powder, composites thereof and combinations thereof. In one embodiment, the particles of the powder are nano-scale particles. In one embodiment, the nano-scale particles have a diameter between about 1 nm and about 100 nm. In one embodiment, the particles of the powder are micro-scale particles. In one embodiment, the particles of the powder include aggregated micro-scale particles. In one embodiment, the micro-scale particles have a diameter between about 2 μm and about 15 μm. The particles generally include the components used to form the first electrolyte containing material 114 (114a, 114b) and the second electrolyte containing material 112 (112a, 112b). A layer of material formed on the surface of a substrate, which contains the particles of the powder will be referred to below as the as-deposited layer.

In certain embodiments, the powder 210 may be combined with a carrying medium prior to application of the powder 210. In one embodiment, the carrying medium may be a liquid that is atomized before entering the processing chamber. The carrying medium may also be selected to nucleate around the electrochemical nanoparticles to reduce attachment to the walls of the processing chamber. Suitable liquid carrying media include water and organic liquids such as alcohols or hydrocarbons. The alcohols or hydrocarbons will generally have low viscosity, such as about 10 cP or less at operating temperature, to afford reasonable atomization. In other embodiments, the carrying medium may also be a gas such as helium, argon, or nitrogen in other embodiments. In certain embodiment, use of a carrying medium with a higher viscosity to form a thicker covering over the powder may be desirable.

In certain embodiments, a precursor used to facilitate binding of the powder with the substrate is blended with the powder prior to deposition on the substrate. The precursor may comprise a binding agent, such as a polymer, to hold the powder on the surface of the substrate. The binding agent will generally have some electrical conductivity to avoid diminishing the performance of the deposited layer. In one embodiment, the binding agent is a carbon containing polymer having a low molecular weight. The low molecular weight polymer may have a number average molecular weight of less than about 10,000 to promote adhesion of the nanoparticles to the substrate. Exemplary binding agents include, but are not limited to, polyvinylidene difluoride (PVDF) and water-soluble binders, such as butadiene styrene rubber (BSR).

In one embodiment, the powder 210 may be applied by either wet or dry powder application techniques. Whether the majority of powder 210 is deposited over or into the pockets 220 is dependent upon a number of factors which may be modified to achieve desired deposition including the size of the pockets 220, the size of the particles of the powder 210, the type of application technique used, and the process conditions of the application technique used. In one embodiment, the powder may be applied by powder application techniques including but not limited to sifting techniques, electrostatic spraying techniques, thermal or flame spraying techniques, fluidized bed coating techniques, slit coating techniques, roll coating techniques, and combinations thereof, all of which are known to those skilled in the art. One exemplary process is a two-pass deposition process wherein a first pass deposits powder using a spray coating method to infiltrate the pockets 220 of the container layer 202 followed by a second pass to deposit additional powder via a slit coating process.

In certain embodiments, electrostatic spraying methods are used to deposit powder over and/or into the plurality of pockets 220. Electrostatic spraying charges the powder particles and then sprays the powder particles toward the area to be coated, such as pocket 220, with an opposite and attractive electric charge. Since the charged powders in the spray stream are attracted toward the area to be coated, the electrostatic process helps minimize overspray and waste.

In certain embodiments, fluidized bed coating methods may be used to insert powder over and/or into the plurality of pockets 220. In fluidized bed systems, air is blown up through a porous bed or screen to suspend the powder thereby forming a fluidized bed. The item to be coated is inserted into the fluidized bed allowing the powder coating particles to stick onto the exposed surfaces. Coating powders in a fluidized bed can also be charged for the application of thicker coatings.

In certain embodiments, thermal or flame spraying techniques may be used to deposit powder over and/or into the plurality of pockets 220. Thermal spraying techniques are coating processes in which melted (or heated) materials are sprayed onto a surface. The “feedstock” (coating precursor) is heated by electrical (e.g. plasma or arc) or chemical means (e.g. combustion flame). Coating materials available for thermal spraying include metals, alloys, ceramics, plastics and composites. The coating materials are fed in powder form, heated to a molten or semi-molten state and accelerated towards the substrate in the form of micrometer-size particles. Combustion or electrical arc discharge is usually used as the source of energy for thermal spraying. Exemplary thermal spraying techniques and apparatus are described in commonly assigned U.S. Provisional Patent Application Ser. No. 61/236,387, filed Aug. 24, 2009, to Shang et al., titled IN-SITU DEPOSITION OF BATTERY ACTIVE LITHIUM MATERIALS BY THERMAL SPRAYING, which is herein incorporated by reference in its entirety.

In one embodiment, prior to or during the deposition of the powder 210, it may be desirable to deposit wetting agents or use other facilitation techniques including ultrasonic or megasonic agitation, grounding, or biasing to assist in the insertion of the powder 210 into the pockets 220.

In one embodiment, as shown in FIG. 2C, after deposition of the powder 210 over and/or into the pockets 220, there is an amount of overfill 230 extending above an upper surface of the conductive microstructure 200. The overfill 230 may comprise a series of peaks 225 and troughs 226 on the surface of the powder 210.

In one embodiment, the overfill 230 extends between about 1 μm and about 20 μm above the upper surface of the conductive microstructure 200. In one embodiment, the overfill 230 extends between about 2 μm and about 5 μm above the upper surface of the conductive microstructure 200. In certain embodiments, it may be desirable to overfill the pockets 220 with powder 210 to achieve a desired net density of powder 210 after compression of the powder. Although shown as overfill, it should also be understood that in certain embodiments it may be desirable to underfill the pockets 220 with powder. In certain embodiments, underfilling of the pocket 220 with powder 210 may be desirable to accommodate electrochemical expansion of the powder 210. In certain embodiments, the pocket 220 may be filled with powder 210 to a level substantially even with the upper surface of the conductive microstructure 200 or the upper surface of the pocket 220. As described below with reference to FIG. 2D, after the powder 210 is deposited over the pockets 220, the powder may be compressed using compression techniques, for example, a calendaring process, to achieve a desired net density of compacted powder while planarizing the powder that extends above the upper surface of the conductive microstructure.

In general, an anode structure 102 that has conductive microstructures 200 including columnar projections 211 and/or meso-porous structures 212 formed thereon will have a surface that has one or more forms of porosity formed thereon. In one embodiment, the surface of the anode structure 102 comprises a macro-porosity structure wherein the pockets 220 are a plurality of macro-pores. In one embodiment, the pockets 220 are about 100 microns or less in size. It is believed that the size and density of the pockets 220 in the layer can be controlled by controlling the electroplating current density, surface tension of the electrolyte relative to the surface of the substrate, metal-ion concentration in the bath, roughness of the substrate surface, and the fluid dynamic flow. In certain embodiments where an embossing process is used to form the columnar projections 211, the size and density of the pockets 220 may be controlled by, for example, controlling the size of the matched male and female roller dies. In an embossing process, the shapes of the pockets 220 may be controlled by modifying the shapes of the male and female roller dies. In one embodiment, the pockets 220 are sized within a range between about 5 and about 100 microns (μm). In another embodiment, the average size of the pockets 220 is about 30 microns in size. In certain embodiments, the pockets 220 have a depth between about 20 microns to about 100 microns. In certain embodiments, the pockets 220 have a depth between about 30 microns to about 50 microns. In certain embodiments, the pockets 220 have a diameter from about 10 microns to about 80 microns. In certain embodiments, the pockets 220 have a diameter from about 30 microns to about 50 microns. The surface of the anode structure may also comprise a second type, or class, of pore structures or pockets 220 that are formed between the columnar projections 211 and/or main central bodies of the dendrites, which is known as meso-porosity, wherein the pockets 220 include a plurality of meso-pores. The meso-porosity may have a plurality of meso-pores that are less than about 50,000 nanometers in size. The meso-porosity may have a plurality of meso-pores that are less than about 1 micron in size. In another embodiment, the meso-porosity may comprise a plurality of meso-pores that are between about 100 nm to about 1,000 nm in size. In one embodiment, the meso-pores are between about 20 nm to about 100 nm in size. Additionally, the surface of the anode structure 102 may also comprise a third type, or class, of pore structures that are formed between the meso-pores, which is known as nano-porosity. In one embodiment, the nano-porosity may comprise a plurality of nano-pores or pockets 220 that is sized less than about 100 nm. In another embodiment, the nano-porosity may comprise a plurality of nano-pores that are less than about 20 nm in size.

FIG. 2D illustrates the current collector 111 and container layer 202 after compression of the powder 210 into the plurality of pockets 220 formed by the conductive microstructures 200, according to embodiments described herein. After deposition of the powder to fill pockets 220, compression of the powder 210 forms a layer 221 on the conductive microstructures 200 having a substantially planar surface 222. The substantially planar surface 222 results by compression of powder 210 to reduce peaks 225 and troughs 226 apparent in FIG. 2C. Referring to FIG. 2D, the thickness 223 of layer 221 is variable depending on the intercalation layer requirements of the energy storage device that contains anode structure 102. For example, in a Li-ion battery, the powder 210 can serve as an intercalation layer for lithium ions within the anode structure 102. In such an embodiment, a greater thickness 223 of layer 221 results in a greater energy storage capacity for the electrode, but also a greater distance for the charge to travel before entering current collector 111, which can slow charge/discharge times and increase internal resistance. Consequently, thickness 223 of layer 221 may range from between about 10 μm to about 200 μm, for example, between about 50 μm to about 100 μm, depending on the desired functionality of electrode 100. The powder 210 may be compressed using compression techniques known in the art, for example, calendaring.

FIG. 3 illustrates an anode structure 102 after the formation of a separator layer 104 over a layer 221 comprising conductive microstructures 200 and compressed powder 210, according to embodiments of the invention. In one embodiment, the separator layer 104 is a dielectric, porous layer that separates an anode structure from a cathode structure. The porous nature of separator layer 104 allows ions to travel between a first electrolyte containing material, the powder of the anode structure 102 and a second electrolyte containing material of the cathode structure via the liquid portion of the electrolyte contained in the pores of the separator layer 104.

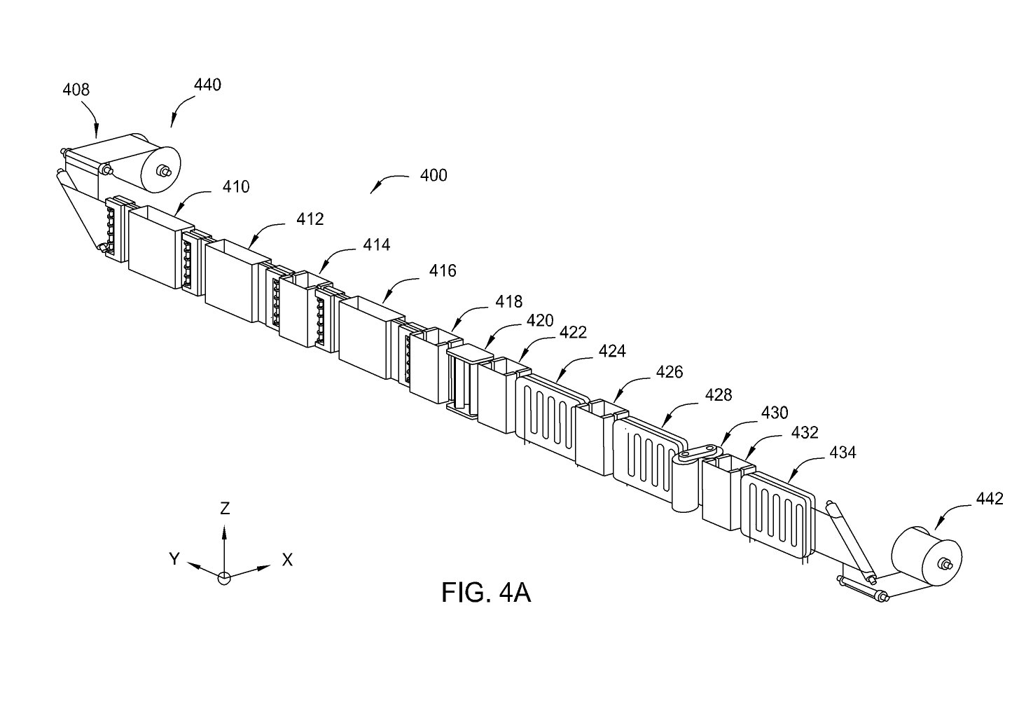

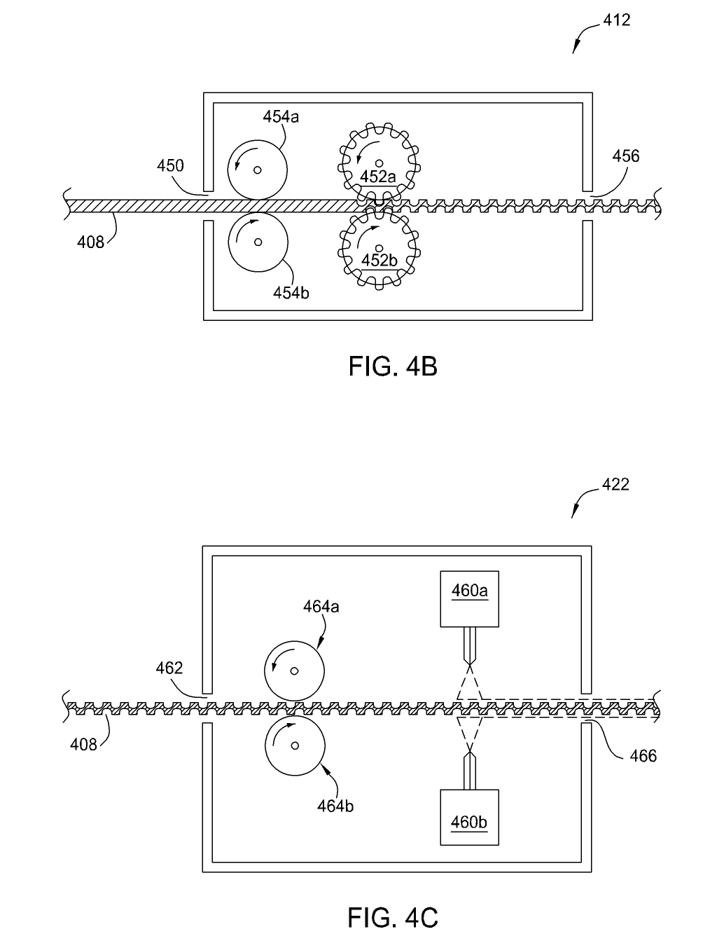

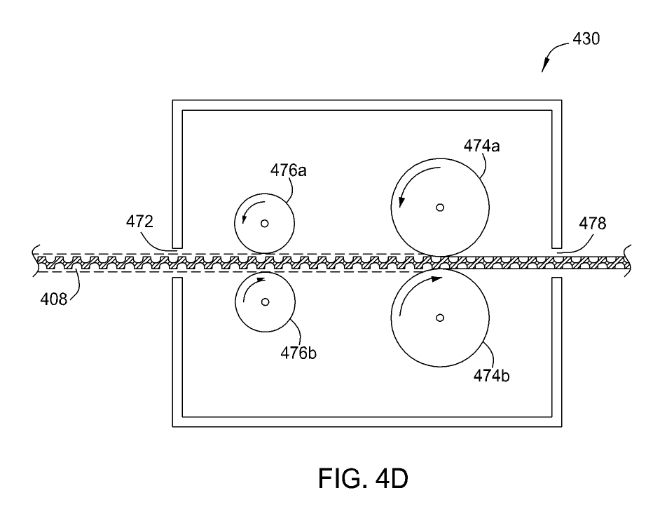

FIG. 4A schematically illustrates one embodiment of a vertical processing system 400 according to embodiments described herein. In certain embodiments, the processing system 400 comprises a plurality of processing chambers 410-434 arranged in a line, each configured to perform one processing step to a vertically positioned flexible conductive substrate 408. In one embodiment, the processing chambers 410-434 are stand alone modular processing chambers wherein each modular processing chamber is structurally separated from the other modular processing chambers. Therefore, each of the stand alone modular processing chambers, can be arranged, rearranged, replaced, or maintained independently without affecting each other. In certain embodiments, the processing chambers 410-434 are configured to process both sides of a vertically oriented conductive flexible substrate 408.

In one embodiment, the processing system 400 comprises a first conditioning module 410 configured to perform a first conditioning process, for example, cleaning at least a portion of the flexible conductive substrate 408 prior to entering a microstructure formation chamber 412.

In certain embodiments, the first conditioning module 410 is configured to heat the flexible conductive substrate 408 prior to entering the microstructure formation chamber 412 to increase the plastic flow of the flexible conductive substrate 408 prior to the microstructure formation process. In certain embodiments, the first conditioning module 410 is configured to pre-wet or rinse a portion of the flexible conductive substrate 408.

The microstructure formation chamber 412 is configured to form pockets or wells in the flexible conductive substrate 408. In certain embodiments, the microstructure formation chamber 412 is an embossing chamber. In certain embodiments, the microstructure formation chamber 412 is a first plating chamber. In certain embodiments, the microstructure formation chamber 412 is a nano-imprinting chamber.

In certain embodiments, where the microstructure formation chamber 412 is an embossing chamber the chamber is configured to emboss both sides of the vertically oriented conductive flexible substrate 408. In certain embodiments, multiple embossing chambers may be used. In certain embodiments, each embossing chamber of the multiple embossing chambers is configured to emboss an opposing side of the vertically oriented conductive flexible substrate 408.

In certain embodiments, the microstructure formation chamber 412 is a plating chamber configured to perform a first plating process, for example, a copper plating process, on at least a portion of the flexible conductive substrate 408 to form pockets or wells in the flexible conductive substrate 408. In certain embodiments, the plating chamber is configured to plate on both sides of the vertically oriented conductive flexible substrate 408. In one embodiment, the first plating chamber is adapted to plate a copper conductive microstructure over the vertically oriented conductive flexible substrate 408.

In certain embodiments, the processing system 400 further comprises a second conditioning chamber 414 positioned adjacent to the microstructure formation chamber 412. In certain embodiments, the second conditioning chamber 414 is configured to perform an oxide removal process, for example, in embodiments where the conductive flexible substrate 408 comprises aluminum, the second conditioning chamber may be configured to perform an aluminum oxide removal process. In certain embodiments, where the microstructure formation chamber 412 is configured to perform a plating process, the second conditioning chamber 414 may be configured to rinse and remove any residual plating solution from the portion of the vertically oriented conductive flexible substrate 408 with a rinsing fluid, for example, de-ionized water, after the first plating process.

In one embodiment, the processing system 400 further comprises a second plating chamber 416 disposed next to the second conditioning chamber 414. In one embodiment, the second plating chamber 416 is configured to perform a plating process. In one embodiment, the second plating chamber 416 is adapted to deposit a second conductive material, for example, tin, over the vertically oriented conductive flexible substrate 408. In one embodiment, the second plating chamber 416 is adapted to deposit a nano-structure over the vertically oriented conductive substrate 408.

In one embodiment, the processing system 400 further comprises a rinse chamber 418 configured to rinse and remove any residual plating solution from the portion of the vertically oriented conductive flexible substrate 408 with a rinsing fluid, for example, de-ionized water, after the plating process. In one embodiment, a chamber 420 comprising an air-knife is positioned adjacent to the second rinse chamber 418.

In one embodiment, the processing system 400 further comprises an active material deposition chamber 422. In certain embodiments, the active material deposition chamber 422 is a first spray coating chamber configured to deposit an anodically or cathodically active powder, similar to powder 210, over and/or into the conductive microstructure 200 on the vertically oriented conductive substrate 408. In one embodiment, the active material deposition chamber 422 is a spray coating chamber configured to deposit powder over the conductive microstructures formed over the flexible conductive substrate 408 and to subsequently compress the powder to a desired height. In one embodiment, deposition of the powder and compression of the powder are performed in separate chambers. Although discussed as a spray coating chamber, the active material deposition chamber 422 may be configured to perform any of the aforementioned powder deposition processes.

In one embodiment, the processing system 400 further comprises an annealing chamber 424 disposed adjacent to the active material deposition chamber 422 configured to expose the vertically oriented conductive substrate 408 to an annealing process. In one embodiment, the annealing chamber 424 is configured to perform a drying process such as a rapid thermal annealing process.

In one embodiment, the processing system 400 further comprises a second active material deposition chamber 426 positioned adjacent to the annealing chamber 424. In one embodiment, the second active material deposition chamber 426 is a spray coating chamber. Although discussed as a spray coating chamber, the second active material deposition chamber 426 may be configured to perform any of the aforementioned powder deposition processes. In one embodiment, the second active material deposition chamber 426 is configured to deposit an additive material such as a binder over the vertically oriented conductive substrate 408. In certain embodiments where a two pass spray coating process is used, the first active material deposition chamber 422 may be configured to deposit powder over the vertically oriented conductive substrate 408 during a first pass using, for example, an electrostatic spraying process, and the second active material deposition chamber 426 may be configured to deposit powder over the vertically oriented conductive substrate 408 in a second pass using, for example, a slit coating process.

In one embodiment, the processing system 400 further comprises a first drying chamber 428 disposed adjacent to the second active material deposition chamber 426 configured to expose the vertically oriented conductive substrate 408 to a drying process. In one embodiment, the first drying chamber 428 is configured to perform a drying process such as an air drying process, an infrared drying process, or a marangoni drying process.

In one embodiment, the processing system 400 further comprises a compression chamber 430 disposed adjacent to the first drying chamber 428 configured to expose the vertically oriented conductive substrate 408 to a calendaring process to compress the deposited powder into the conductive microstructure. In one embodiment, the compression chamber 430 is configured to compress the powder via a calendaring process.

In one embodiment, the processing system 400 further comprises a third active material deposition chamber 432 positioned adjacent to the compression chamber 430. Although discussed as a spray coating chamber, the third active material deposition chamber 432 may be configured to perform any of the aforementioned powder deposition processes. In one embodiment, the third active material deposition chamber 432 is configured to deposit a separator layer over the vertically oriented conductive substrate.

In one embodiment, the processing system 400 further comprises a second drying chamber 434 disposed adjacent to the third active material deposition chamber 432 configured to expose the vertically oriented conductive substrate 408 to a drying process. In one embodiment, the second drying chamber 434 is configured to perform a drying process such as an air drying process, an infrared drying process, or a marangoni drying process.

The processing chambers 410-434 are generally arranged along a line so that portions of the vertically oriented conductive substrate 408 can be streamlined through each chamber through feed roll 440 and take up roll 442. In one embodiment, each of the processing chambers 410-434 has separate feed rolls and take-up rolls. In one embodiment, the feed rolls and take-up rolls may be activated simultaneously during substrate transferring to move each portion of the flexible conductive substrate 408 one chamber forward.

In certain embodiments where a cathode structure is formed, chamber 414 may be replaced with a chamber configured to perform aluminum oxide removal. In certain embodiments where a cathode structure is formed, chamber 416 may be replaced with an aluminum electro-etch chamber.

In certain embodiments, the vertical processing system 400 further comprises additional processing chambers. The additional processing chambers may comprise one or more processing chambers selected from the group of processing chambers comprising an electrochemical plating chamber, an electroless deposition chamber, a chemical vapor deposition chamber, a plasma enhanced chemical vapor deposition chamber, an atomic layer deposition chamber, a rinse chamber, an anneal chamber, a drying chamber, a spray coating chamber, and combinations thereof. It should also be understood that additional chambers or fewer chambers may be included in the in-line processing system. Further, it should be understood that the process flow depicted in FIG. 4A is only exemplary and that the processing chambers may be rearranged to perform other process flows which occur in different sequences.

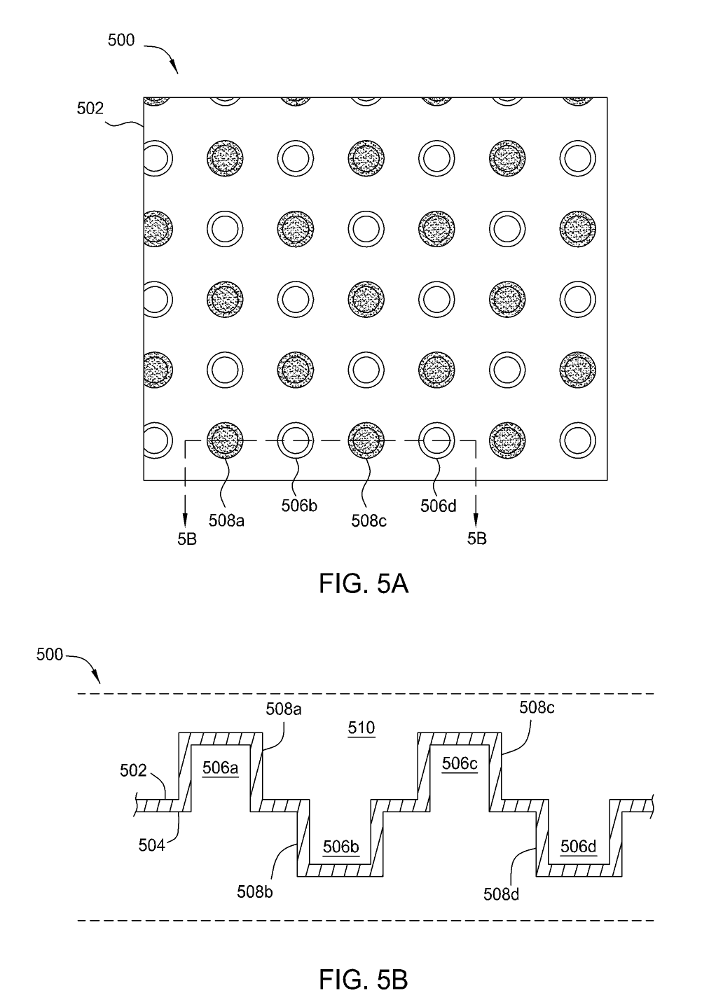

It should also be understood that although discussed as a system for processing a vertically oriented substrate, the same processes may be performed on substrates having different orientations, for example, a horizontal orientation. Details of a horizontal processing system that can be used with the embodiments described herein are disclosed in commonly assigned U.S. patent application Ser. No. 12/620,788, titled APPARATUS AND METHOD FOR FORMING 3D NANOSTRUCTURE ELECTRODE FOR ELECTROCHEMICAL BATTERY AND CAPACITOR, to Lopatin et al., filed Nov. 18, 2009, now published as US2010-0126849 of which FIGS. 5A-5C, 6A-6E, 7A-7C, and 8A-8D and text corresponding to the aforementioned figures are incorporated by reference herein. In certain embodiments, the vertically oriented substrate may be slanted relative to a vertical plane. For example, in certain embodiments, the substrate may be slanted from between about 1 degree to about 20 degrees from the vertical plane.

FIG. 4B is a schematic sectional top view of one embodiment of the microstructure formation chamber 412 depicted as an embossing chamber according to embodiments described herein. In certain embodiments, after conditioning of the flexible conductive substrate 408, the flexible conductive substrate 408 enters the chamber 412 through a first opening 450 where the flexible conductive substrate 408 is embossed or patterned by a pair of embossing members 452a, 452b, for example, a pair of cylindrical embossing die using a calendar rotary press, in chamber 412. The flexible conductive substrate 408 is drawn through the pair of embossing members to produce the desired pocket pattern on the flexible conductive substrate 408. In one embodiment, the flexible conductive substrate 408 generally moves by virtue of take up and feed rolls 454a, 454b and exits the chamber 412 via a second opening 456. In one embodiment, the embossing members 452a, 452b compress the flexible conductive substrate 408 during the embossing process. In certain embodiments, the chamber 412 further comprises a heater for heating the flexible conductive substrate to increase the plastic flow of the vertically oriented flexible conductive substrate.

In one embodiment, the embossing members 452a and 452b comprise two engraved and mated hardened rolls. The embossing members 452a and 452b may comprise any materials compatible with the process chemistries. In one embodiment, the embossing members 452a and 452b comprise stainless steel. In certain embodiments, the width and diameter of the embossing members 452a and 452b may be determined by any of the following: the width of the flexible conductive substrate, the material thickness, the desired pattern depth, and material tensile strength and hardness.

As shown in FIG. 4B, in certain embodiments each embossing member 452a and 452b comprise male and female rotary die portions where the male rotary die portions of each embossing member 452a and 452b are offset from each other such that the desired pockets or wells may be formed on opposing sides of the flexible conductive substrate 408. It should also be understood that as the desired pockets are formed on one side of the flexible substrate 408, the pocket forms a corresponding projection on the opposing side of the flexible substrate 408. Although embossing members 452a and 452b are depicted as comprising male and female rotary die portions, it should be understood that any know embossing apparatus that forms the desired pockets or wells in the flexible conductive substrate 408 may be used with the present embodiments. For example, in certain embodiments, embossing member 452a is a male rotary die and embossing member 452b is a mated female rotary die. In certain embodiments, embossing member 452a comprises a male rotary die and embossing member 452b comprises a deformable rotary die. In one embodiment, the deformable rotary die has elastomeric properties. In certain embodiments, the chamber 412 comprises multiple sets of embossing members. For example, in one embodiment, an additional set (not shown) of rotary die are included in the chamber 412. The additional set of male and female rotary die may be reversed relative to the initial set of male and female rotary die such that the additional set of rotary die form pockets or wells on the opposite side of the flexible conductive substrate 408.

It should also be understood that pockets of different shapes can be produced on the flexible conductive substrate 408 depending on the roller dies used. For example, the pockets may have any desired shape including, square shapes with sharp edges and shapes where the edges are “rounded” (curved without sharp angles) such as semi-circular, conical, and cylindrical shapes.

FIG. 4C is a schematic side view of one embodiment of the active material deposition chamber 422 configured to translate the flexible substrate 408 through the active material deposition chamber 422 having opposing powder dispensers 460a, 460b disposed across the travel path of the flexible substrate 408. The active material deposition chamber 422 may be configured to perform either wet or dry powder application techniques. The active material deposition chamber 422 may be configured to perform the following powder application techniques including but not limited to sifting techniques, electrostatic spraying techniques, thermal or flame spraying techniques, fluidized bed coating techniques, roll coating techniques, and combinations thereof, all of which are known to those skilled in the art.

A flexible substrate 408 or substrate enters the chamber through a first opening 462 and travels between the powder dispensers 460a, 460b, which deposits the powder over the conductive microstructure on the flexible substrate 408. In one embodiment, the powder dispensers 460a, 460b each comprise multiple dispensing nozzles oriented across the path of the flexible conductive substrate 408 to cover the substrate uniformly as it travels between the powder dispensers 460a, 460b. The flexible conductive substrate 408 generally moves by virtue of take up rolls and feed rolls 464a, 464b. In certain embodiments, a powder dispenser with multiple nozzles such as the powder dispensers 460a, 460b may be configured with all nozzles in a linear configuration, or in any other convenient configuration. To achieve full coverage of the flexible conductive substrate 408, the dispenser may be translated across the flexible conductive substrate 408 while spraying activated material, or the flexible conductive substrate 408 may be translated between the dispensers 460a, 460b, or both, according to methods similar to that described above. In certain embodiments, where it is desirable to expose the powder to an electric field, the active material deposition chamber 422 further comprises an electrical source (not shown), for example, an RF or DC source. The substrate 408 having been covered with the powder, exits the active material deposition chamber 422 through a second opening 466 for further processing.

FIG. 4D is a schematic sectional side view of one embodiment of a compression chamber 430 according to embodiments described herein. After deposition of the powder from the powder dispensers 460a, 460b, the flexible conductive substrate 408 enters the chamber through a first opening 472 where the deposited powder is compressed by a pair of compression members 474a, 474b, for example, a pair of rotary cylinders, in chamber 430. The flexible conductive substrate 408 generally moves by virtue of take up and feed rolls 476a, 476b and exits the chamber 407 via second opening 478. In one embodiment, the compression members 474a, 474b contact and compress the as-deposited powder using, for example, a calendaring process.

FIG. 5A is a perspective top view of a dual sided micro-patterned conductive substrate 500 formed according to embodiments described herein. FIG. 5B is a cross-sectional view of a dual sided micro-patterned conductive substrate 500 taken along line 5B-5B of FIG. 5A according to embodiments described herein. The dual-sided micro-patterned substrate 500 comprises a first side 502 and an opposing second side 504. The micro-patterned substrate 500 has a plurality of pockets or wells 506a-d and a plurality of columns or posts 508a-d formed using an embossing process as previously described. In certain embodiments, as shown in FIG. 5B, the pockets 506a-d and posts 508a-d are formed from the substrate 500 itself. In certain embodiments, pockets 506a and 506c and corresponding posts 508a and 508c may be formed by exposing the second side 504 to an embossing process as described herein. In certain embodiments, pockets 506b and 506d and corresponding posts 508b and 508d were formed by exposing the first side 502 to the embossing process. In certain embodiments, the pockets 506a-d and posts 508a-d are formed using a dual sided embossing process. In certain embodiments, pockets 506b and 506d on the first side 502 of the conductive substrate 500 are formed in a first embossing step and pockets 506a and 506c on the second side 504 of the substrate 500 are formed using a second embossing step. As shown in FIG. 5B, as the pockets are formed on one side of the micro-patterned conductive substrate 500, the pockets form a corresponding projection or post on the opposing side of the micro-patterned conductive substrate 500.

In certain embodiments, the conductive substrate 500 may comprise any of the conductive materials previously described including but not limited to aluminum, stainless steel, nickel, copper, and combinations thereof. The conductive substrate 500 may be in the form of a foil, a film, or a thin plate. In certain embodiments, the conductive substrate 500 may have a thickness that generally ranges from about 1 to about 200 μm. In certain embodiments, the conductive substrate 500 may have a thickness that generally ranges from about 5 to about 100 μm. In certain embodiments, the conductive substrate 500 may have a thickness that ranges from about 10 μm to about 20 μm.

In certain embodiments, the pockets 506a-d have a depth between about 1 micron to about 1,000 microns. In certain embodiments, the pockets 506a-d have a depth between about 5 microns to about 200 microns. In certain embodiments, the pockets 506a-d have a depth between about 20 microns to about 100 microns. In certain embodiments, the pockets 506a-d have a depth between about 30 microns to about 50 microns. In certain embodiments, the pockets have a diameter from about 10 microns to about 80 microns. In certain embodiments, the pockets have a diameter from about 30 microns to about 50 microns. Although shown as having a square shape with sharp edges, it should be understood that the pockets 506a-d may have any desired shape, including shapes where the edges are “rounded” (curved without sharp angles) such as semi-circular, conical, and cylindrical shapes. In certain embodiments, the embossing process may further comprise a material removal process such as an etching process to further shape the pockets and posts formed on the conductive substrate 500.

The pockets may be filled with a cathodically active powder 510 selected from the group comprising: lithium cobalt dioxide (LiCoO₂), lithium manganese dioxide (LiMnO₂), titanium disulfide (TiS₂), LiNixCO₁₋₂ₓMnO₂, LiMn₂O₄, iron olivine (LiFePO₄) and it is variants (such as LiFe₁₋ₓMgPO₄), LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, and other qualified powders.

FIG. 6 is a process flow chart summarizing one embodiment of a method 600 for forming an electrode structure similar to anode structure 102 as illustrated in FIGS. 1, 2A-2F, and 3, according to embodiments described herein. In block 602, a substrate substantially similar to current collector 111 in FIG. 1 is provided. As detailed above, the substrate may be a conductive substrate, such as metallic foil, or a non-conductive substrate that has an electrically conductive layer formed thereon, such as a flexible polymer or plastic having a metallic coating.

In block 604, a three-dimensional conductive microstructure having pockets similar to conductive microstructure 200 is deposited over the current collector 111. The conductive micro-structure may be formed using a plating process, an embossing process, a nano-imprinting process, a wire mesh, or combinations thereof.

In one embodiment, the three-dimensional microstructure having pockets may be formed using an embossing process, for example, similar to the embossing process used to form the dual sided micro-patterned conductive substrate 500 discussed in FIGS. 5A and 5B.

In embodiments where a plating process is used to form the conductive microstructure, columnar projections similar to conductive columnar projections 211 in FIG. 2B are formed on a conductive surface of the current collector 111. In one embodiment, the columnar projections 211 may have a height of 5 to 10 microns and/or have a measured surface roughness of about 10 microns. In another embodiment, the columnar projections 211 may have a height of 15 to 30 microns and/or have a measured surface roughness of about 20 microns. In one embodiment, a diffusion-limited electrochemical plating process is used to form the columnar projections 211. In one embodiment, the three dimensional growth of the columnar projections 211 is performed using a high plating rate electroplating process performed at current densities above the limiting current (i_{L}). Formation of the columnar projections 211 includes establishing process conditions under which evolution of hydrogen results, thereby forming a porous metal film. In one embodiment, such process conditions are achieved by performing at least one of: decreasing the concentration of metal ions near the surface of the plating process; increasing the diffusion boundary layer; and reducing the organic additive concentration in the electrolyte bath. It should be noted that the diffusion boundary layer is strongly related to the hydrodynamic conditions. If the metal ion concentration is too low and/or the diffusion boundary layer is too large at a desired plating rate, the limiting current (i_{L}) will be reached. The diffusion-limited plating process created when the limiting current is reached forms the increase in plating rate by the application of more voltage to the surface of the plating process, e.g., a seed layer surface on current collector 111. When the limiting current is reached, low density columnar projections, i.e., columnar projections 211, are produced due to the evolution of gas and resulting meso-porous type film growth that occurs due to the mass-transport-limited process.

Suitable plating solutions that may be used with the processes described herein include electrolyte solutions containing a metal ion source, an acid solution, and optional additives. Suitable plating solutions are described in commonly assigned U.S. patent application Ser. No. 12/696,422, entitled, POROUS THREE DIMENSIONAL COPPER, TIN, COPPER-TIN, COPPER-TIN-COBALT, AND COPPER-TIN-COBALT-TITANIUM ELECTRODES FOR BATTERIES AND ULTRA CAPACITORS, to Lopatin et al., filed on Jan. 29, 2010, which is incorporated herein by reference to the extent not inconsistent with the present disclosure.

The columnar projections 211 are formed using a diffusion limited deposition process. The current densities of the deposition bias are selected such that the current densities are above the limiting current (i_{L}). The columnar metal film is formed due to the evolution of hydrogen gas and resulting meso-porous film growth that occurs due to the mass transport limited process. In one embodiment, during formation of columnar projections 211, the deposition bias generally has a current density of about 10 A/cm² or less. In another embodiment, during formation of columnar projections 211, the deposition bias generally has a current density of about 5 A/cm² or less. In yet another embodiment, during formation of columnar projections 211, the deposition bias generally has a current density of about 3 A/cm² or less. In one embodiment, the deposition bias has a current density in the range from about 0.05 A/cm² to about 3.0 A/cm². In another embodiment, the deposition bias has a current density between about 0.1 A/cm² and about 0.5 A/cm². In yet another embodiment, the deposition bias has a current density between about 0.05 A/cm² and about 0.3 A/cm². In yet another embodiment, the deposition bias has a current density between about 0.05 A/cm² and about 0.2 A/cm². In one embodiment, this results in the formation of columnar projections between about 1 micron and about 300 microns thick on the copper seed layer. In another embodiment, this results in the formation of columnar projections between about 10 microns and about 30 microns. In yet another embodiment, this results in the formation of columnar projections between about 30 microns and about 100 microns. In yet another embodiment, this results in the formation of columnar projections between about 1 micron and about 10 microns, for example, about 5 microns. In embodiments where a substrate similar to micro-patterned conductive substrate 500 is used, embossing may be used to form the three dimensional conductive microstructure (e.g. pockets and posts) of the substrate.

In certain embodiments, a conductive meso-porous structure substantially similar to meso-porous structure 212 in FIG. 2B is formed on the substrate or current collector 111. The conductive meso-porous structures may be formed on the columnar projections 211, or formed directly on the flat conductive surface of the substrate or current collector 111. In embodiments where the substrate is similar to the micro-patterned conductive substrate 500, the conductive meso-porous structures may be formed over the posts and pockets. In one embodiment, an electrochemical plating process may be used to form the conductive meso-porous structures, and in another embodiment, an electroless plating process may be used.

The electrochemical plating process for forming conductive meso-porous structures similar to meso-porous structures 212 involves exceeding the electro-plating limiting current during plating to produce an even lower-density meso-porous structure than columnar projections 211. Otherwise, the process is substantially similar to the electroplating process for forming columnar projections 211 and may be performed in-situ. The electric potential spike at the cathode during this step is generally large enough so that reduction reactions occur, hydrogen gas bubbles form as a byproduct of the reduction reactions at the cathode, while meso-porous structures are constantly being formed on the exposed surfaces. The formed dendrites grow around the formed hydrogen bubbles because there is no electrolyte-electrode contact underneath the bubble. In a way, these microscopic bubbles serve as “templates” for meso-porous growth. Consequently, these anodes have many pores when deposited according to embodiments described herein.

In sum, when an electrochemical plating process is used to form meso-porous structures 212 on columnar projections 211, a three-dimensional conductive microstructure may be formed at a first current density by a diffusion limited deposition process, followed by the optional three dimensional growth of meso-porous structures 212 at a second current density, or second applied voltage, that is greater than the first current density, or first applied voltage.

In block 606 a powder, similar to powder 210 is deposited over the three-dimensional structure having pockets. In one embodiment, the powder comprises particles selected from the group comprising graphite, graphene hard carbon, carbon black, carbon coated silicon, tin particles, copper-tin alloy particles, tin oxide, silicon carbide, silicon (amorphous or crystalline), silicon alloys, doped silicon, lithium titanate, any other appropriately electro-active powder, composites thereof and combinations thereof. In one embodiment, the powder may be applied by powder application techniques including but not limited to sifting techniques, electrostatic spraying techniques, thermal or flame spraying techniques, fluidized bed coating techniques, roll coating techniques, slit coating, and combinations thereof, all of which are known to those skilled in the art.

In one embodiment, in block 608, an optional annealing process is performed. During the annealing process, the substrate may be heated to a temperature in a range from about 100° C. to about 250° C., for example, between about 150° C. and about 190° C. Generally, the substrate may be annealed in an atmosphere containing at least one anneal gas, such as O₂, N₂, NH₃, N₂H₄, NO, N₂O, or combinations thereof. In one embodiment, the substrate may be annealed in ambient atmosphere. The substrate may be annealed at a pressure from about 5 Torr to about 100 Torr, for example, at about 50 Torr. In certain embodiments, the annealing process serves to drive out moisture from the pore structure. In certain embodiments, for example, where a copper-tin structure is used, the annealing process serves to diffuse atoms into the copper base, for example, annealing the substrate allows tin atoms to diffuse into the copper base, making a much stronger copper-tin layer bond.

In one embodiment, the substrate is exposed to a combustion chemical vapor deposition (CVD) process prior to the annealing process.

In block 610, binder is optionally applied to the flexible conductive substrate. The binder may be applied by powder application techniques including but not limited to sifting techniques, electrostatic spraying techniques, thermal or flame spraying techniques, fluidized bed coating techniques, roll coating techniques, slit coating techniques, and combinations thereof, all of which are known to those skilled in the art.

In block 612, the conductive microstructure with the as-deposited powder may be exposed to an optional drying process in order to accelerate drying of the powder in embodiments where wet powder application techniques are used. Drying processes which may be used include but are not limited to air drying process, an infrared drying process, or a marangoni drying process.

In block 614, the conductive microstructure with the as-deposited powder may be exposed to an optional compression process to compress the powder to achieve a desired net density of compacted powder. Compression processes which may be used include but are not limited to calendaring.

In block 616, a separator layer is formed. In one embodiment, the separator layer is a dielectric, porous, fluid-permeable layer that prevents direct electrical contact between the components in the anode structure and the cathode structure. Alternatively, the separator layer is deposited onto the surface of the meso-porous structure and may be a solid polymer, such as polyolefin, polypropylene, polyethylene, and combinations thereof. In one embodiment, the separator layer comprises a polymerized carbon layer comprising a densified layer of meso-porous carbon material on which a dielectric layer may be deposited or attached.

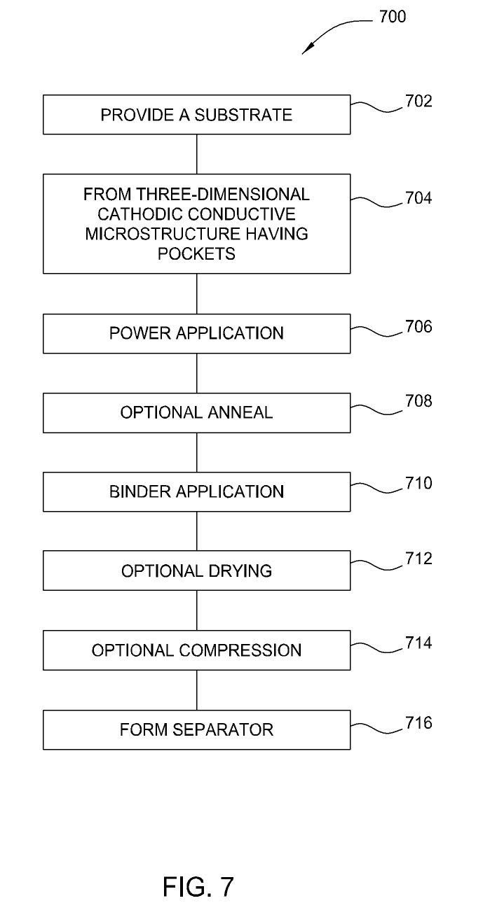

FIG. 7 is a process flow chart summarizing one embodiment of a method 700 for forming an electrode structure such as a cathode structure according to embodiments described herein. In block 702, a substrate similar to current collector 113a, 113b shown in FIG. 1 is provided. As detailed above, the substrate may be a conductive substrate, such as metallic foil, or a non-conductive substrate that has an electrically conductive layer formed thereon, such as a flexible polymer or plastic having a metallic coating. In one embodiment, the substrate or current collector 113a, 113b is an aluminum substrate or an aluminum alloy substrate. In one embodiment, the current collector 113a, 113b is perforated.

At block 704 a three-dimensional structure is formed on the substrate. In one embodiment, the three-dimensional structure may be formed using, for example, a nano-imprint lithography process. In one embodiment, the nano-imprint lithography process is used to form an etch mask. The etch mask is then used in combination with an etching process, such as, a reactive ion etching process to transfer the nano-imprint into the substrate. There are two well known types of nano-imprint lithography that are applicable to the present disclosure. The first is thermoplastic nano-imprint lithography [T-NIL], which includes the following steps: (1) coat the substrate with a thermoplastic polymer resist; (2) bring a mold with the desired three-dimensional pattern in contact with the resist and apply a prescribed pressure; (3) heat the resist above its glass transition temperature; (4) when the resist goes above its glass transition temperature the mold is pressed into the resist; (5) cool the resist and separate the mold from the resist, leaving the desired three-dimensional pattern in the resist.

The second type of nano-imprint lithography is photo nano-imprint lithography [P-NIL], which includes the following steps: (1) a photo-curable liquid resist is applied to the substrate; (2) a transparent mold, with the desired three-dimensional pattern, is pressed into the liquid resist until the mold makes contact with the substrate; (3) the liquid resist is cured in ultraviolet light, to turn the liquid resist into a solid; (4) the mold is separated from the resist, leaving the desired three-dimensional pattern in the resist. In P-NIL the mold is made of a transparent material such as fused silica.

In one embodiment, the three-dimensional structure comprises a wire mesh structure. In one embodiment the wire mesh structure comprises a material selected from aluminum and alloys thereof. In one embodiment, the wire mesh structure has a wire diameter between about 0.050 micrometers and about 10 micrometers. In one embodiment, the wire mesh structure has an aperture between about 10 micrometers and about 100 micrometers. In certain embodiments, it may be desirable to use the wire mesh structure as the three-dimensional cathode structure since it does not require nano-imprinting or etching.

In one embodiment, the three-dimensional structure is formed using embossing techniques as described herein.

In block 706 a powder, similar to powder 510 is deposited over the three-dimensional structure. The powder comprises a powder that includes the components to form the lithium containing oxides disclosed above. In one embodiment, the powder may be applied by powder application techniques including but not limited to sifting techniques, electrostatic spraying techniques, thermal or flame spraying techniques, fluidized bed coating techniques, roll coating techniques, slit coating techniques, and combinations thereof, all of which are known to those skilled in the art. In certain embodiments, the powder 510 may comprises nano-particles and/or micro-particles as previously described herein.

In block 708, an optional annealing process may be performed as described with reference to the anode structure. Binder is applied to the substrate in block 710. The binder may be applied by powder application techniques including but not limited to sifting techniques, electrostatic spraying techniques, thermal or flame spraying techniques, fluidized bed coating techniques, roll coating techniques, slit coating techniques, and combinations thereof, all of which are known to those skilled in the art.

In block 712 an optional drying process may be performed as described with reference to the anode structure. In block 714 an optional compression process similar to the process described in block 614, for example, calendaring, may be performed. In block 716 a separator layer may as described in block 616 may be formed to complete the cathode structure.

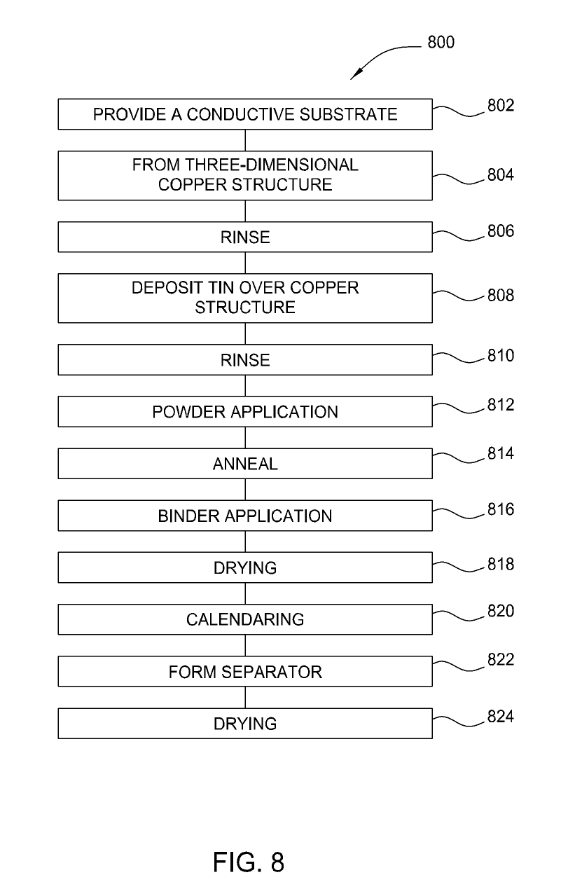

FIG. 8 is a process flow chart summarizing one embodiment of a method 800 for forming an anode structure according to embodiments described herein. In block 802, a conductive copper substrate is provided. In block 804, a three-dimensional copper structure having pockets is formed over the conductive copper substrate. In block 806, the structure is exposed to a rinsing process to remove any residual plating solution and contaminants. In block 808, tin is deposited over the three dimensional copper structure. In block 810, the copper-tin structure is exposed rinsing process to remove any residual plating solution and contaminants. Powder is applied over and into the pockets of the three-dimensional structure in block 812. The structure is annealed in block 814. In block 816, binder is applied over and into the pockets of the three-dimensional structure. In block 818 a drying process is performed as described with reference to the anode structure. In block 820 a calendaring process to extrude the powder and binder into the pockets is performed. In block 822 a separator layer is formed to complete the anode structure. In block 824, the anode structure is exposed a drying process.

FIG. 9 is a process flow chart summarizing a method 900 for forming a portion of the lithium-ion battery similar to lithium-ion battery 100 illustrated in FIG. 1, according to one embodiment described herein. In step 902, an anode structure similar to anode structure 102a is formed using, for example, method 600 or 800.

In step 904, a cathode structure 103a (FIG. 1) is formed using, for example, method 700, in which a conductive substrate serving as a current collector has multiple thin films deposited thereon to form the cathode structure. The method of forming the cathode structure is similar to method 600, except that as described in relation to FIG. 7, the Li intercalation material is not a carbon material and instead is a metal oxide as detailed above in conjunction with FIG. 1 and the three-dimensional structure may be different. Consequently, when forming the cathode structure 103a, the powder application step, i.e., step 606 is replaced with an active cathodic material deposition step. An active cathode material may be deposited using the powder application methods described herein, or other methods known in the art. In one embodiment, the active cathode material is deposited by coating cathode structure 103a with a slurry containing lithium metal oxide particles.

In step 906, the anode structure and the cathode structure are joined together to form a complete supercapacitor or a battery cell substantially similar in organization and operation to a portion of Li-ion battery 100. In one embodiment, a fluidic electrolyte, i.e., either a liquid or polymeric electrolyte, is added to the anode structure and/or the cathode structure prior to joining the two structures together. Techniques for depositing an electrolyte onto the anode structure and/or the cathode structure include: PVD, CVD, wet deposition, spray-on and sol-gel deposition. The electrolyte may be formed from Lithium Phosphorous OxyNitride (LiPON), lithium-oxygen-phosphorus (LiOP), lithium-phosphorus (LiP), lithium polymer electrolyte, lithium bisoxalatoborate (LiBOB), lithium hexafluorophosphate (LiPF₆) in combination with ethylene carbonate (C₃H₄O₃), and dimethylene carbonate (C₃H₆O₃). In another embodiment, ionic liquids may be deposited to form the electrolyte.

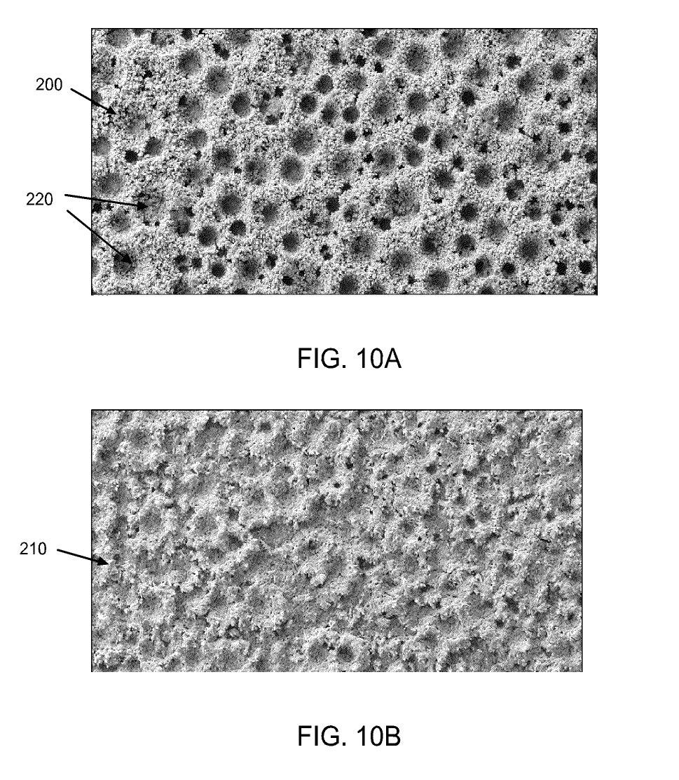

FIG. 10A is a schematic representation of a scanning electron microscope (SEM) image of a copper-tin structure prior to deposition of powder according to embodiments described herein. As shown in FIG. 10A, the conductive microstructures 200 form a plurality of pockets 220.

FIG. 10B is a schematic representation of a scanning electron microscope (SEM) image of the copper-tin structure of FIG. 10A after deposition of a powder 210 over the copper-tin structure.

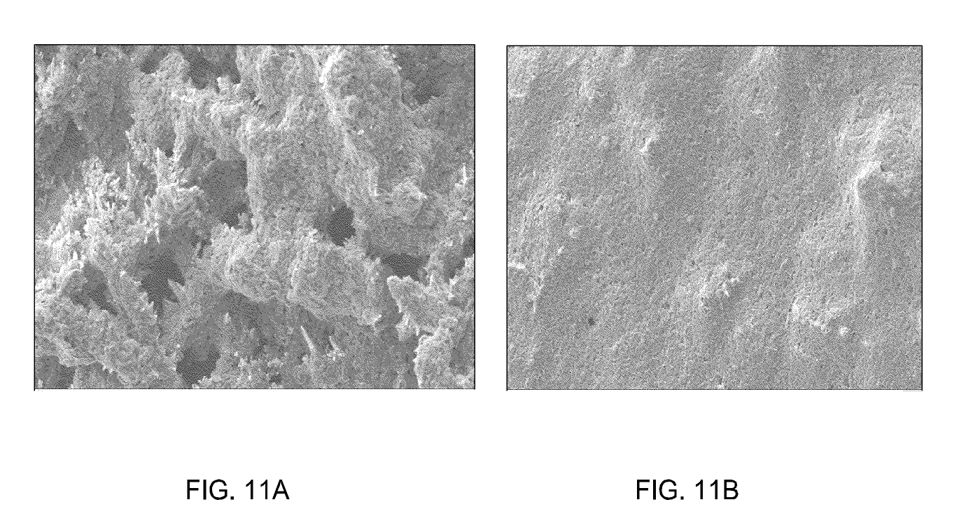

FIG. 11A is a schematic representation of a scanning electron microscope (SEM) image of a copper-tin container structure after deposition of graphite and a water soluble binder. FIG. 11B is a schematic representation of a scanning electron microscope (SEM) image of a copper-tin container structure after compression of the graphite and water soluble binder of FIG. 11A.

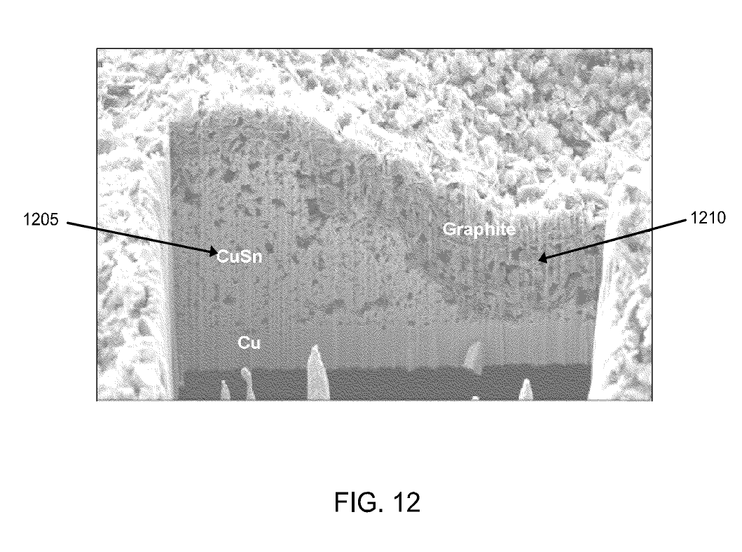

FIG. 12 is a schematic representation of a scanning electron microscope (SEM) image of a cross-section of a copper-tin container structure 1205 partially filled with graphite powder 1210.

While the foregoing is directed to embodiments of the present invention, other and further embodiments of the invention may be devised without departing from the basic scope thereof, and the scope thereof is determined by the claims that follow.

1. A battery bi-layer cell, comprising:
an anode structure comprising:
a conductive collector substrate;
a plurality of pockets formed on the conductive collector substrate by conductive microstructures comprising a plurality of columnar projections; and
an anodically active powder deposited in and over the plurality of pockets;
an insulative separator layer formed over the plurality of pockets; and
a cathode structure joined over the insulative separator.

2. The battery bi-layer cell of claim 1, wherein the cathode structure comprises:
a micro-patterned collector substrate comprising aluminum or alloys thereof;
a plurality of pockets and posts formed in the micro-patterned substrate; and
a cathodically active powder deposited over the plurality of pockets formed in the micro-patterned substrate.

3. The battery bi-layer cell of claim 2, wherein the plurality of pockets and posts of the cathode are formed using an embossing process.

4. The battery bi-layer cell of claim 2, wherein the cathodically active powder is selected from the group comprising: lithium cobalt dioxide (LiCoO₂), lithium manganese dioxide (LiMnO₂), titanium disulfide (TiS₂), LiNixCO₁₋₂ₓMnO₂, LiMn₂O₄, iron olivine (LiFePO₄), LiFe₁₋ₓMgPO₄, LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, and combinations thereof.

5. The battery bi-layer cell of claim 1, wherein the conductive microstructures further comprise a plurality of meso-porous structures.

6. The battery bi-layer cell of claim 1, wherein the anodically active powder is selected from graphite, graphene hard carbon, carbon black, carbon coated silicon, tin particles, copper-tin particles, tin oxide, silicon carbide, amorphous silicon, crystalline silicon, silicon alloys, doped silicon, lithium titanate, and combinations thereof.

7. An anode structure for use in an electrochemical cell device comprising:
a conductive collector substrate;
a container layer comprising a plurality of porous pockets formed on one or more surfaces of the conductive collector substrate by conductive microstructures comprising a plurality of meso-porous structures formed over a plurality of columnar projections; and
an anodically active powder deposited into and over the plurality of pockets.

8. The anode structure of claim 7, wherein the conductive microstructures are formed by an electroplating process, an electroless process, an embossing process, or combinations thereof.

9. The anode structure of claim 7, wherein the conductive microstructures form the container layer having a density that is between about 10% and about 85% of a solid film formed from the same material.

10. The anode structure of claim 7, wherein the conductive microstructure comprises a material selected from the group comprising: copper, tin, doped silicon, and combinations thereof.

11. The anode structure of claim 10, wherein the anodically active powder comprises particles selected from the group comprising graphite, graphene hard carbon, carbon black, carbon coated silicon, tin particles, copper-tin particles, tin oxide, silicon carbide, amorphous silicon, crystalline silicon, silicon alloys, doped silicon, lithium titanate, composites thereof and combinations thereof.

12. The anode structure of claim 7, wherein the plurality of columnar projections comprise a macro-porous structure that has a plurality of macroscopic pores between about 5 and about 200 microns in size and the plurality of meso-porous structures have a plurality of meso-pores that are between about 10 nanometers and about 1,000 nanometers in size.

13. The anode structure of claim 7, wherein the powder fills the plurality of porous pockets and at least a portion of the anodically active powder extends above a top surface of the conductive microstructure forming a planar surface.

14. The anode structure of claim 7, wherein the powder is compressed and extruded within the plurality of porous pockets such that the powder does not extend above a top surface of the conductive microstructure.

15. A cathode structure for use in an electrochemical device comprising:
a micro-patterned conductive collector substrate comprising aluminum or alloys thereof;
a plurality of pockets formed on one or more surfaces of the micro-patterned substrate; and
a cathodically active powder deposited into and over the plurality of pockets.

16. The cathode structure of claim 15, wherein the plurality of pockets are formed using embossing techniques or nano-imprinting techniques.

17. The cathode structure of claim 15, wherein the cathodically active powder comprises particles selected from the group comprising: LiCoO₂, LiNiₓCo₁₋₂ₓMnO₂, LiNi_{0.5}Mn_{1.5}O₄, Li(Ni_{0.8}Co_{0.15}Al_{0.05})O₂, LiMn₂O₄, LiFePO₄, LiFe₁₋ₓMgPO₄, LiMoPO₄, LiCoPO₄, LiNiPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Li₂FeSiO₄, Li₂MnSiO₄, Li₂VOSiO₄, Na₅V₂(PO₄)₂F₃, and combinations thereof.

18. The cathode structure of claim 15, wherein the cathodically active powder fills the pockets and at least a portion of the powder extends above a top surface of the plurality of pockets.

19. The cathode structure of claim 15, wherein the cathodically active powder is compressed and extruded within the pockets such that the powder does not extend above a top surface of the plurality of pockets.

20. A substrate processing system for processing a flexible conductive substrate, comprising:
a microstructure formation chamber configured to form a plurality of conductive pockets over a flexible conductive substrate;
an active material deposition chamber for depositing electro-active powders over the plurality of conductive pockets; and
a substrate transfer mechanism configured to transfer the flexible conductive substrate among the chambers, comprising:
a feed roll configured to retain a portion of the flexible conductive substrate;
a take up roll configured to retain a portion of the flexible conductive substrate, wherein the substrate transfer mechanism is configured to activate the feed rolls and the take up rolls to transfer the flexible conductive substrate in and out of each chamber, and hold the flexible conductive substrate in a processing volume of each chamber.

21. The substrate processing system of claim 20, wherein the microstructure formation chamber comprises an embossing chamber configured to emboss both sides of the flexible substrate to form the plurality of conductive pockets.

22. The substrate processing system of claim 20, wherein the microstructure formation chamber comprises a plating chamber configured to perform a plating process on at least a portion of the flexible conductive substrate to form the plurality of conductive pockets.

23. The substrate processing system of claim 20, further comprising:
a conditioning chamber positioned adjacent to the microstructure formation chamber and configured to perform at least one of: cleaning at least a portion of the flexible conductive substrate, heating a portion of the flexible conductive substrate to increase the plastic flow of the flexible conductive substrate prior to the microstructure formation process, and combinations thereof.

24. The substrate processing system of claim 20, wherein the active material deposition chamber comprises:
a powder dispenser disposed across a travel path of the flexible substrate, wherein the powder dispenser is configured to perform powder application techniques including sifting techniques, electrostatic spraying techniques, thermal or flame spraying techniques, fluidized bed coating techniques, roll coating techniques, slit coating techniques, and combinations thereof.

25. The substrate processing system of claim 20, further comprising:
a compression chamber configured to expose the flexible conductive substrate to a calendaring process to compress the deposited powder into the plurality of pockets.
